(19) United States
(12) Patent Application Publication
(10) Pub. No.: US 2026/0175584 A1
(43) Pub. Date: Jun. 25, 2026

(54) PRINTING SYSTEM WITH A CLEANING SYSTEM AND A METHOD THEREFOR

(71) Applicant: CANON KABUSHIKI KAISHA, Tokyo (JP)

(72) Inventors: Laurentius P.E.G. KUIJPERS, Someren (NL); Age BAKKER, Broekhuizenvorst (NL); Richard VAN ENCKEVORT, Velden (NL)

(21) Appl. No.: 19/422,199

(22) Filed: Dec. 16, 2025

(30) Foreign Application Priority Data
Dec. 19, 2024 (EP) 24221696.8

(51) Int. Cl. B41J 2/165; B41J 29/13

(52) U.S. Cl. CPC B41J 2/16538; B41J 2/16544; B41J 29/13; B41J 2002/16573

(57) ABSTRACT

A printing system including a print engine having printing elements configured to print on print media, a print controller to control the printing on print media by the print engine, and a cleaning system having at least one cleaning material configured to clean an environment of the printing elements. The cleaning system includes at least one safety switch and at least one mechanical lock to respectively electrically shut down and physically isolate at least a part of the cleaning system in order to enable safe access for the operator for replacement of the at least one cleaning material during printing.

### CROSS-REFERENCE TO RELATED APPLICATIONS

This application claims priority to European Patent Application No. 24221696.8 filed on December 19, 2024, which is incorporated by reference herein in its entirety.

### BACKGROUND OF THE DISCLOSURE

### Field of the Disclosure

The present disclosure relates to a printing system having a print engine for printing on print media by means of printing elements, a print controller to control the printing on print media by the print engine and a cleaning system for cleaning an environment of the printing elements by means of at least one cleaning material. The present disclosure also relates to a method for the printing system. The printing system may also be referred to as a printer hereinafter.

### Description of Background Art

Current printing systems like an inkjet printing system have a cleaning system to clean a nozzle plate or the nozzles at regular time intervals or when there is a detection of a nozzle failure. The cleaning system may have wipe units to wipe pollution or waste ink from the nozzle plate.

Replacing wipe units in a printing system or the tissue ribbon of the wipe unit is done by switching off the printing system to get safe access to the part in the system. Switching off, replacing the part and switching the system back on to continue production easily takes a substantial amount of time and can be a daily or bi-daily routine depending on the amount of cleaning that is related to production amount. In the end, the replacement of parts of the cleaning system counts as productivity loss, or down-time, where the printing system cannot produce output.

### SUMMARY OF THE DISCLOSURE

The present disclosure is directed to a printing system with the cleaning system such that operators can have safe access to the cleaning system, without having to switch off the entire printer for replacing cleaning materials.

In accordance with the present disclosure, the cleaning system is provided with at least one safety switch to electrically isolate the cleaning system during printing of sheets by the printing system.

The disclosure allows safe access for the operator for replacement of the at least one cleaning material during printing.

The disclosure has at least two more advantages: less production loss and/or more uptime, and scheduling the replacement of cleaning materials is easier, since the replacement can be done during production, i.e. it does not matter much when the replacement takes place.

According to an embodiment, the cleaning system is positioned at a home position in the printing system besides of the printing elements and the cleaning system is moveable underneath the printing elements when cleaning is executed.

According to an embodiment, the cleaning system is provided with a closing element to limit access to the cleaning system and surroundings of the cleaning system such that only parts that need to be replaced are accessible. The at least one safety switch is configured to power off actuators that drive parts in the cleaning system, and a mechanical lock is configured to switch in order to secure a fixed position of the cleaning system such that the unpowered cleaning system is not moved or pushed in the printing system. Only parts that need to be replaced are accessible, the rest of the cleaning system is not accessible via the closing element. The actuators may drive parts of the cleaning units in the cleaning system and of the cleaning system itself. The actuators are switched off to avoid mechanical hazard in case of an uncontrolled error or fault situation.

According to an embodiment, the cleaning system is provided with at least one mechanical lock to lock at least a part of the cleaning system during printing of sheets by the printing system.

According to an embodiment, the mechanical lock is configured to secure a fixed position of the cleaning system such that the unpowered cleaning system is not moved or pushed in the printing system.

The mechanical lock prevents that at least a part of the unpowered cleaning system is moved or pushed deeper in the printing system, which could create more access to parts in the printing system that are still active for the printing process by the print engine. The mechanical lock is operated via an actuator but keeps locking when it is switched off by the safety switch before access for replacing cleaning materials is allowed by the print controller of the printer to the operator of the printing system.

According to an embodiment, the printing system is an inkjet printing system and the cleaning system comprises at least one wipe unit.

According to an embodiment, the cleaning material to be replaced is the at least one wipe unit, a tissue ribbon of the at least one wipe unit, or other cleaning materials for cleaning printheads.

The present disclosure also relates to a method for replacing cleaning materials in a cleaning system of a printing system according to the present disclosure , the method comprising the steps of: the print controller receiving a trigger that a cleaning material should be replaced, putting the cleaning system into a physical state to create access with a locked position of the cleaning system, electrically disconnecting the cleaning system from the print engine by means of the at least one safety switch, simultaneously printing by the print engine on print media and replacing the cleaning material in the cleaning system, upon receipt of a trigger that the cleaning material is replaced, electrically reconnecting the cleaning system to the print engine by means of the at least one safety switch, unlocking the cleaning system, and reactivating the electrical control of the actuators and the cleaning system. According to an embodiment, the steps of electrically disconnecting the cleaning system from the print engine and electrically reconnecting the cleaning system to the print engine are automatically performed.

According to an embodiment, the steps of electrically disconnecting the cleaning system from the print engine and electrically reconnecting the cleaning system to the print engine are performed by an operator by means of a user interface of the printing system.

According to an embodiment, the trigger that the cleaning material is replaced is a closing of a closing element suitable for closing the cleaning system.

The present disclosure also relates to a non-transitory storage medium comprising executable program code configured to, when executed on a printing system comprising a cleaning system, enable the printing system to perform the steps of the method according to the present disclosure.

Further scope of applicability of the present disclosure will become apparent from the detailed description given hereinafter. However, it should be understood that the detailed description and specific examples, while indicating embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic cross-sectional, side view of a representation of a printer according to the present disclosure;

FIG. 2 is a schematic drawing of the cleaning system according to the present disclosure;

FIGS. 3A-3D are an example of a schematic drawing of the cleaning process in a printer according to the present disclosure;

FIG. 4 is a schematic flow diagram of a method according to the present disclosure;

FIG. 5 is a schematic user interface screen for replacement of cleaning material; and

FIG. 6 is a schematic diagram of a computer readable medium according to the present disclosure.

### DETAILED DESCRIPTION OF THE EMBODIMENTS

The present disclosure will now be described with reference to the accompanying drawings, wherein the same reference numerals have been used to identify the same or similar elements throughout the several views.

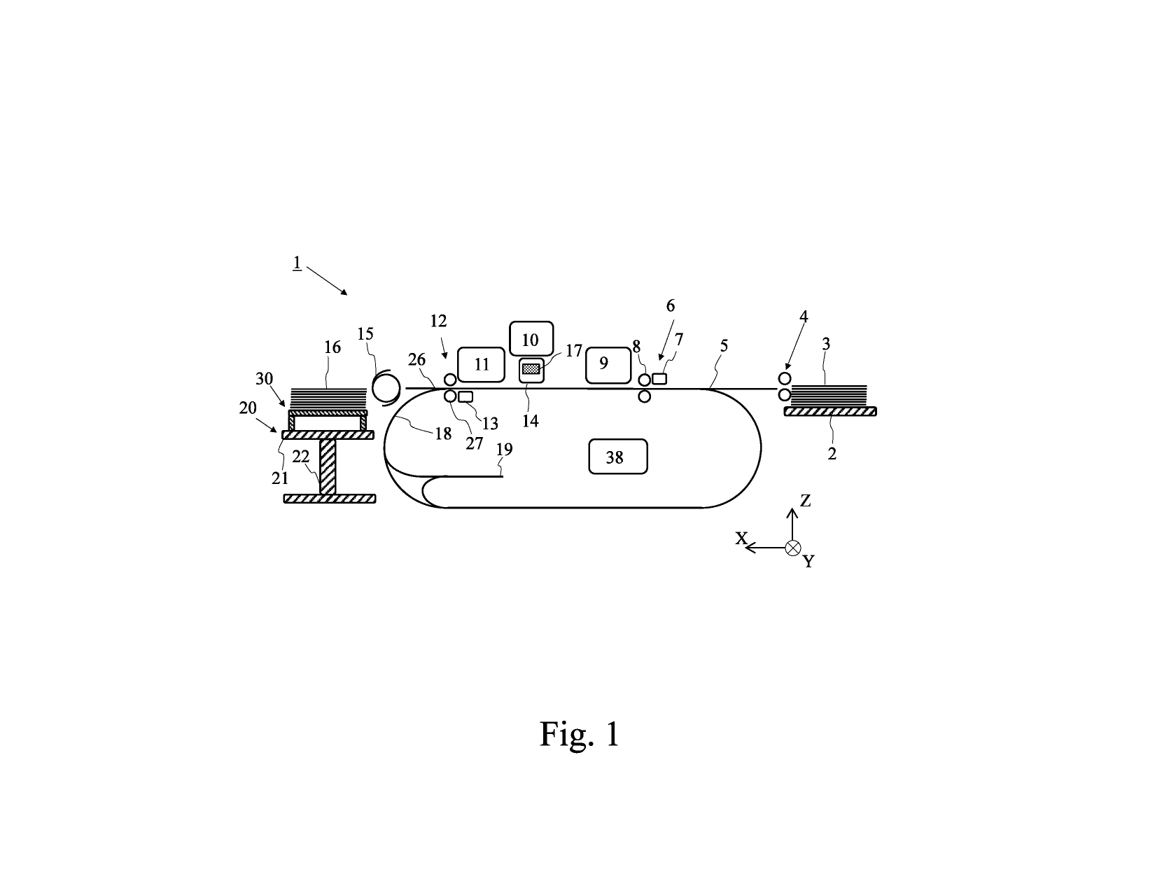

FIG. 1 illustrates a printer 1 according to the present disclosure. An input module 4 on the right side includes one or more input stack supports 2 supporting at least one stack 3 of sheets. The stack supports may be pallets or print media trays. Individual sheets are separated from the stack 3 by the input module 4, which places the sheets on an input path of the printer 1. The input module 4 may include a separator to separate individual sheets from the stack 3. The input path brings the sheets to a print path section, illustrated as a straight, linear path, where the sheet is processed for printing thereon. The print path section includes a switch 5 positioned at an intersection of the input path and a duplex path, which duplex path is arranged to return printed sheets to the print path. Sheets on the print path can thus be a mix of unprinted or one-side printed sheets.

The print path includes a first registration unit 6 downstream of the switch 5. The first registration unit 6 includes a first sheet detector 7 detecting a position and orientation of each sheet. The orientation of the sheet is e.g. the angle of its forward facing or leading edge with respect to the transport direction X. Dependent on the measured position and orientation, the first registration unit 6 controls its registration drive 8 to position the sheet to a predefined position and/or align the sheet to a predefined orientation, for example with its leading edge perpendicular to the transport direction X, so that it will be parallel to the printhead assembly 10.

The registered sheet subsequently may pass a coater 9, which applies a liquid coating on at least a portion of the treated surface. The coater 9 may for example include an array of printheads configured to jet droplets of coating liquid or include a roller for transferring coating liquid as the roller rolls over the sheet. Any suitable coating liquid may be applied, such as for example Canon ColorGrip. The coating liquid preferably forms a continuous coat on the sheet, which enables or improves the bonding of color inks to the sheet.

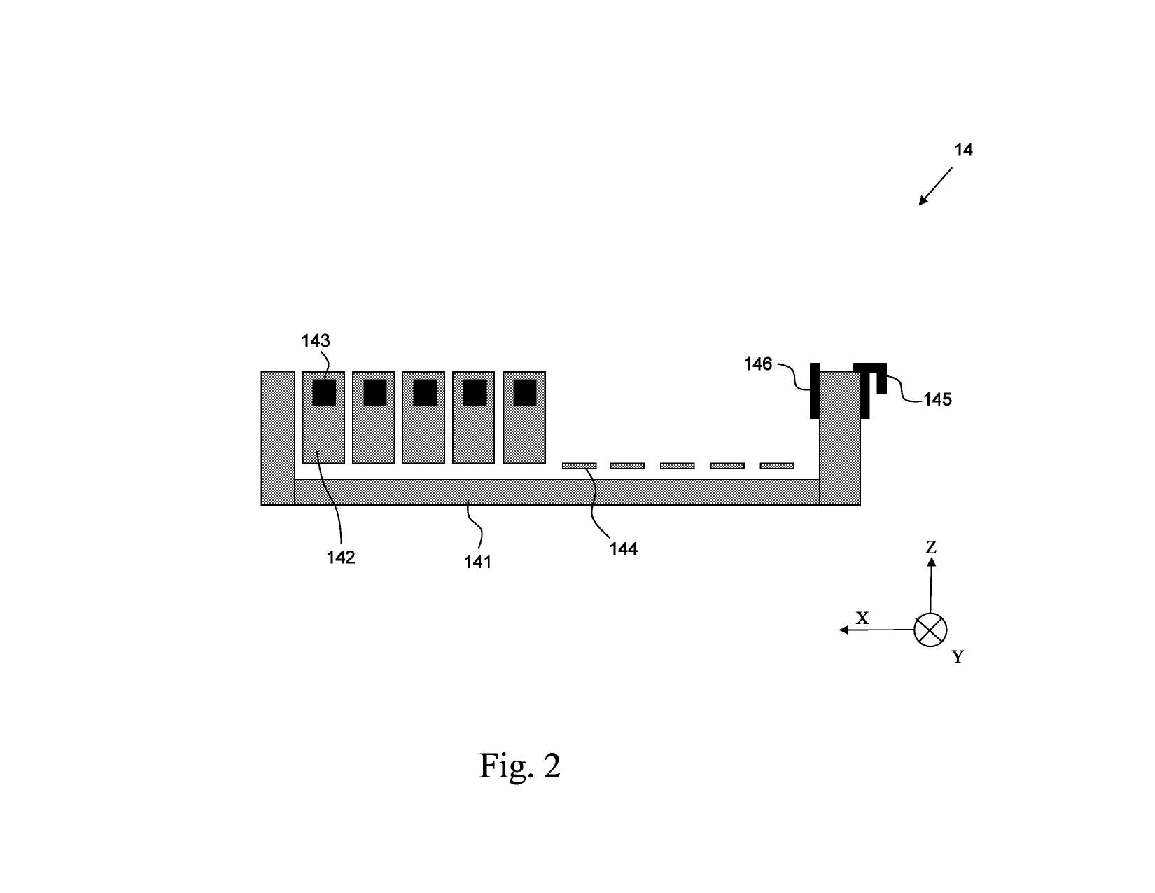

The coated sheets travel to the printhead assembly 10, which jets one or more layers of color inks onto the coated sheet. The printhead assembly 10 is preferably a page wide array of inkjet printheads to allow productive printing. Each inkjet print head includes a nozzle plate including a plurality of nozzles. A nozzle is an exit point of an ink chamber. Ink is jetted out of the ink chamber into the nozzle, for example by piezo-electrical pulses. The nozzle ejects the ink on the sheets of print media. Besides of the print head assembly 10, the printer 1 includes a cleaning system 14 for cleaning the nozzle plate and/or the nozzles. The cleaning system 14 moves bi-directionally in the Y direction perpendicular to the transport direction X in between the print path and the printhead assembly 10. The printhead assembly 10 is lifted to make room for the cleaning system 14 to move underneath the printheads to make a wiping motion. The cleaning system 14 includes replaceable parts and/or consumables that needs to be replaced after a predetermined amount of time and/or use. The cleaning system 14 of the printer 1 may include at least one wipe unit which includes at least one tissue ribbon. The wipe unit may be completely replaced or just a tissue ribbon of a wipe unit may be replaced. A closing element 17 in the housing of the printer 1 gives access to the cleaning system 14 during a cleaning material replacement or wipe unit replacement. The closing element 17 may be a hatch or a door. The cleaning system 14 according to the present disclosure will be elucidated in further detail in FIG. 2.

The jetted color inks are then fixed onto the sheet by means of a fixation unit 11. The fixation unit 11 applies or removes energy from the sheet, so that the jetted color inks undergo a phase change. The fixation unit 11 may include coolers and/or heaters, such radiation heaters with e.g. UV or IR light, hot air blowers, such as impingement blowers, contact heaters, such a heated transport belt or drum, etc. Alternatively, or additionally, the fixation unit 11 may include a curing station, which emits light with a wavelength that induces a chemical reaction in the color inks and/or coating liquid, causing these to solidify.

At the downstream side of the print path, a second registration unit 12 is provided to adjust the position and/or orientation of the sheets. This second registration unit 12 may be configured similar to the first registration unit 6. The second registration unit 12 can be applied to position and/or orientation a sheet with respect to a specific output location, for example a stacking location. The second registration unit 12 includes its own registration drive 27 and may include a sheet detector 13, or the sheet’s position can be derived by tracking the sheet’s movement after detection by the first sheet detector 7.

At the end of the print path, a further switch 26 is provided to selectively direct sheets into the duplex path or to the output location. The duplex path preferably includes a turn station 19, which inverts the sheet, so that it leaves the duplex path with its unprinted side eventually facing the printhead assembly 10. The output location in FIG. 1 includes a stacker 20, which gathers the printed sheets in a further stack 16 on a pallet 30 on a pallet support 21. The stacker 20 includes a stacking unit 15, which receives printed sheets and positions these on top of another into the stack 16. The stacking unit 15 may in one example include a rotatable flipping wheel with one or more slots at its circumference for holding a leading edge of a sheet. By rotating the flipping wheel as it holds the sheet, the sheet is flipped, and then released from the slots as the leading edge of the sheet contacts a stop at the bottom side of the flipping wheel. The pallet support 21 of the stacker 20 is provided on a lift 22, so that its position in the vertical direction Z can be adjusted. This allows the top of the stack 16 to be at the working level of the stacking unit 15 as the stack height increases. The pallet support 21 is configured for supporting a pallet 30, though absence of a pallet may be suited for directly stacking sheets on the pallet support 21 as well.

FIG. 2 is a schematic drawing of the cleaning system 14 of FIG. 1 in more detail. The closing element 17 shown in FIG. 1 has been omitted for convenience reasons and in order to give an inner view of the cleaning system 14. The cleaning system includes a housing 141 that includes a plurality of placeholders for wipe units 142. Each wipe unit 142 has a handle 143 for pulling the wipe unit 142 out of the cleaning system 14 in the X direction during maintenance of the wipe unit 142 or a replacement action of the wipe unit 142. In this example, some placeholders 144 are still empty. The cleaning system 14 includes a lock system 145 according to the present disclosure. The lock system 145 is actuated as a switch. The lock system 145 may be any known mechanical lock system that fits into the printing system 1. When the lock is on, the cleaning system is kept in position. After the lock is on, the closing element 17 or door may be opened for cleaning material replacement like a tissue in a wipe unit 142 or replacement of a complete wipe unit 142. The cleaning system 14 is driven by a drive 146 that is actuated by an electrical system (not shown) of the printing system 1. If the drive 146 turns, it is not safe for the operator to reach inside the cleaning system 14 for wiper replacement. The electrical system of the cleaning system is integrated into the electrical system of the printer 1 but can be electrically disconnected and reconnected by a safety switch or electrical circuit (not shown). The electrical safety switch and/or electrical circuit is integrated on control boards of the printing system 1 (not shown). The control boards form an embedded controller that, for example, receives electrical signals from sensors and digital commands from the print controller that is controlling the printing process.

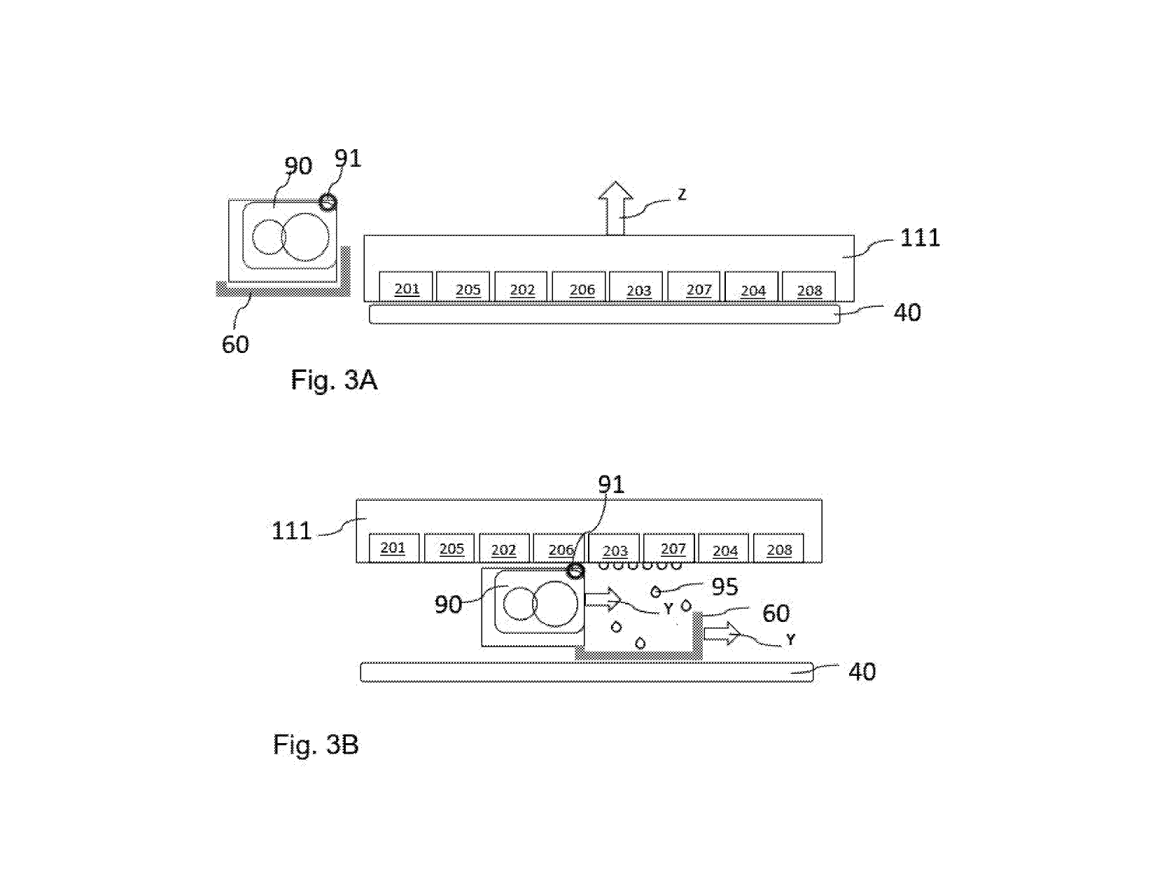

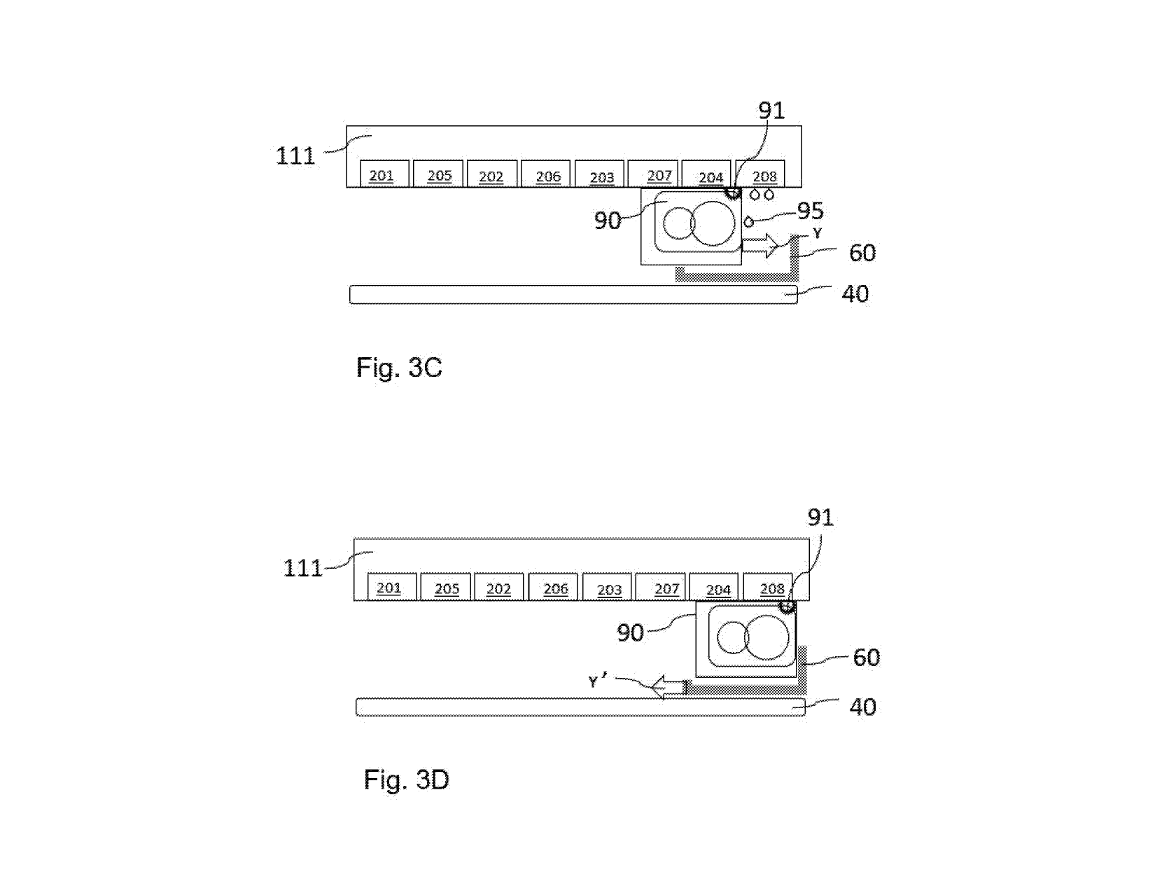

FIGS. 3A-3D is an example of a schematic drawing of the cleaning process in a printer according to the present disclosure.

FIG. 3A shows an inkjet marking device 111, which is an example of a printhead assembly. The printhead assembly 111 includes eight individual inkjet heads 201-208. The printhead assembly 111 is positioned above a print belt 40.

FIG. 3A further shows a cleaning system including a purge tray 60 and a wiping unit 90. The wiping unit 90 shown in FIG. 3A is a tissue wiper unit including a tissue (not shown) and a pressing roller 91 to guide the tissue and press it against a surface of the individual inkjet heads 201-208. The cleaning system is at a home position besides the printhead assembly 111 and is moveable under the printhead assembly 111 when cleaning is required and triggered.

In printing operation, the position of the printhead assembly 111 relative to the print belt 40 is as shown in FIG. 3A. However, the printhead assembly can be moved in direction Z to create more space between the printhead assembly 111 and one or more maintenance units, such as the tissue wiper 90 and the purge tray 60.

In FIG. 3B, the printhead assembly 111 has moved away from print belt 40 in direction Z with respect to the situation shown in FIG. 3A. Direction Z, as shown in FIG. 3A, is a vertical direction. By moving away from the print belt 40, space is created between the print belt 40 and the printhead assembly 111 to allow the purge tray and the wiping unit to move underneath the printhead assembly 111.

As shown in FIG. 3B, the purge tray 60 and the wiping unit move underneath the printhead assembly 111 in direction Y. Direction Y, as shown in FIG. 3B, is a direction parallel to the surface of the print belt 40 and is essentially perpendicular to direction Z.

Inkjet heads 203 and 207 are purging ink droplets 95. These ink droplets are collected by the purge tray 60. After purging, some droplets may stay on the surface of the inkjet heads 203, 207. The wiping unit 90 moves in the direction Y, as does the purge tray 60. The purge tray 60 is more advanced in the direction Y than the wiping unit 90. Hence, the wiping unit 90 can remove any remaining droplets 95 from the surface of the inkjet head 203, 207. Any fluid not absorbed by the tissue (not shown) of the wiping unit 90 may be collected by the purge tray 60.

In FIG. 3C, the purge tray 60 has moved to the end of printhead assembly 111. Inkjet head 208 purges ink, that is collected by the purge tray 60. The wiping unit 90 is still moving in the direction Y. While moving in the direction Y, the wiping unit 90 removes remaining fluid from the surface of inkjet head 208.

In FIG. 3D, the wiping unit 90 has also moved to the end of the printhead assembly 111. The wiping unit 90 is positioned above the purge tray 60. The purge tray 60 and the wiping unit 90 move in the direction Y’, which is opposite to the direction Y. By moving in the direction Y’, the purge tray 60 and the wiping unit 90 may move back to a home position, which is already shown in FIG. 3A. Since the wiping unit 90 is placed above the purge tray 60, the wiping unit 90 and the purge tray 60 may be stored in the home position and needing relatively little space. When replacement of cleaning materials is required, the wiping unit 90 will be moved to the home position, the cleaning system will be electrically isolated from the rest of the printing system and the replacement can take place.

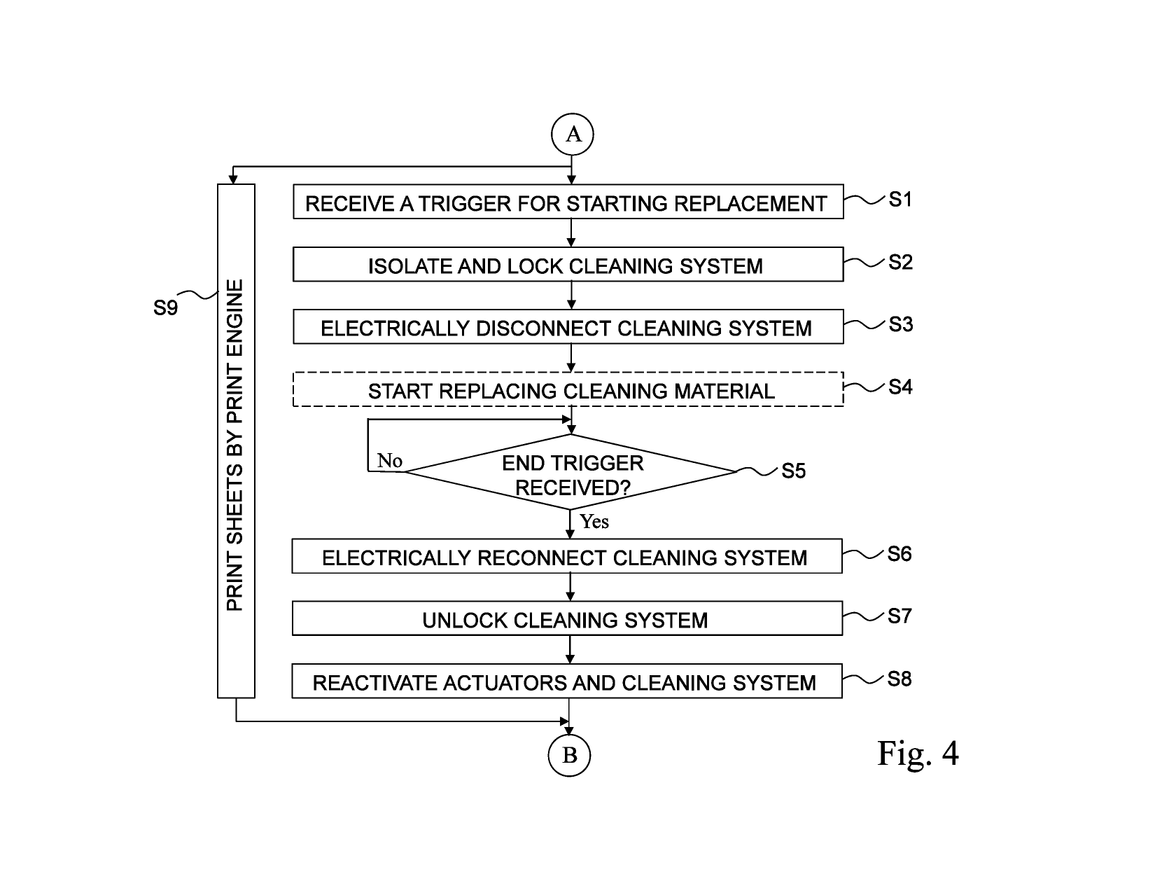

FIG. 4 is a flow diagram of the method according to the present disclosure. The method is suitable for replacing cleaning materials in a cleaning system of a printing system according to the present disclosure. The method starts at a start point A that leads to a first step S1.

In the first step S1, the print controller receives a trigger that a cleaning material should be replaced. The trigger may be originated from a user interface of the printing system or from an opening process of a closing element of the cleaning system.

In a second step S2, the cleaning system is put into a physical state to create access with a locked position of the cleaning system.

In a third step S3, the cleaning system is electrically disconnected from the print engine by means of the at least one safety switch. The third step S3 may be performed automatically or by an operator by means of a user interface of the printer.

In a fourth step S4, the cleaning material is replaced in the cleaning system. The fourth step S4 is indicated with a dashed rectangle since the fourth step S4 is performed manually by an operator of the printing system. It is assumed that the print engine is steadily printing during the previous step S1 – S3 and also in particular during the fourth step S4 as indicated by a ninth step S9. Moreover, the ninth step S9 is assumed to be performed parallel to all steps S1 – S8. In other words, during the whole procedure of the replacement of the cleaning material the print engine is steadily printing.

In a fifth step S5, it is checked if a trigger is received that the replacement of the cleaning material is completely finished. For example, the trigger that the cleaning material is replaced is a closing of the closing element. If a trigger is received, the method proceeds to a sixth step S6. Otherwise, the fifth step S5 is repeated, for example within a predetermined time interval.

In the sixth step S6, the cleaning system is electrically reconnected to the print engine by means of the at least one safety switch. The sixth step S6 may be performed automatically or by an operator by means of a user interface of the printer.

In a seventh step S7, the cleaning system is unlocked by releasing the mechanical lock.

In an eighth step S8, the electrical control of the actuators and the cleaning system is reactivated. The cleaning system is initiated to stand by for eventual cleaning actions commanded by the print controller of the printer.

The method ends at an end point B.

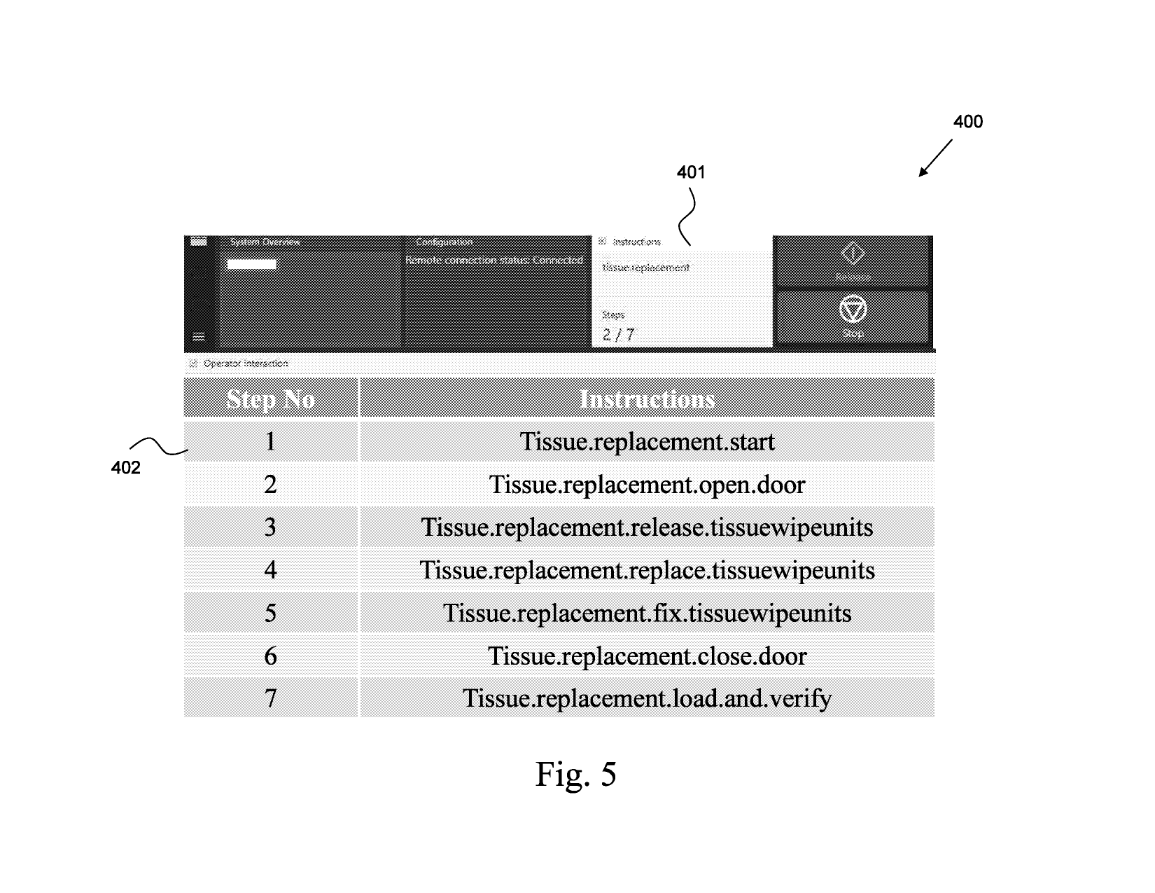

FIG. 5 is a schematic user interface screen 400 for replacement of cleaning material like a tissue wipe unit. According to an embodiment, a trigger that a cleaning material should be replaced is scheduled or detected by the print controller. The print controller sends a dynamic instruction tile 401 to the user interface screen 400 of the printing system. When opening the dynamic instruction tile 401 by the operator, an instruction list 402 is displayed. The instruction list includes a number of steps for executing the cleaning material replacement.

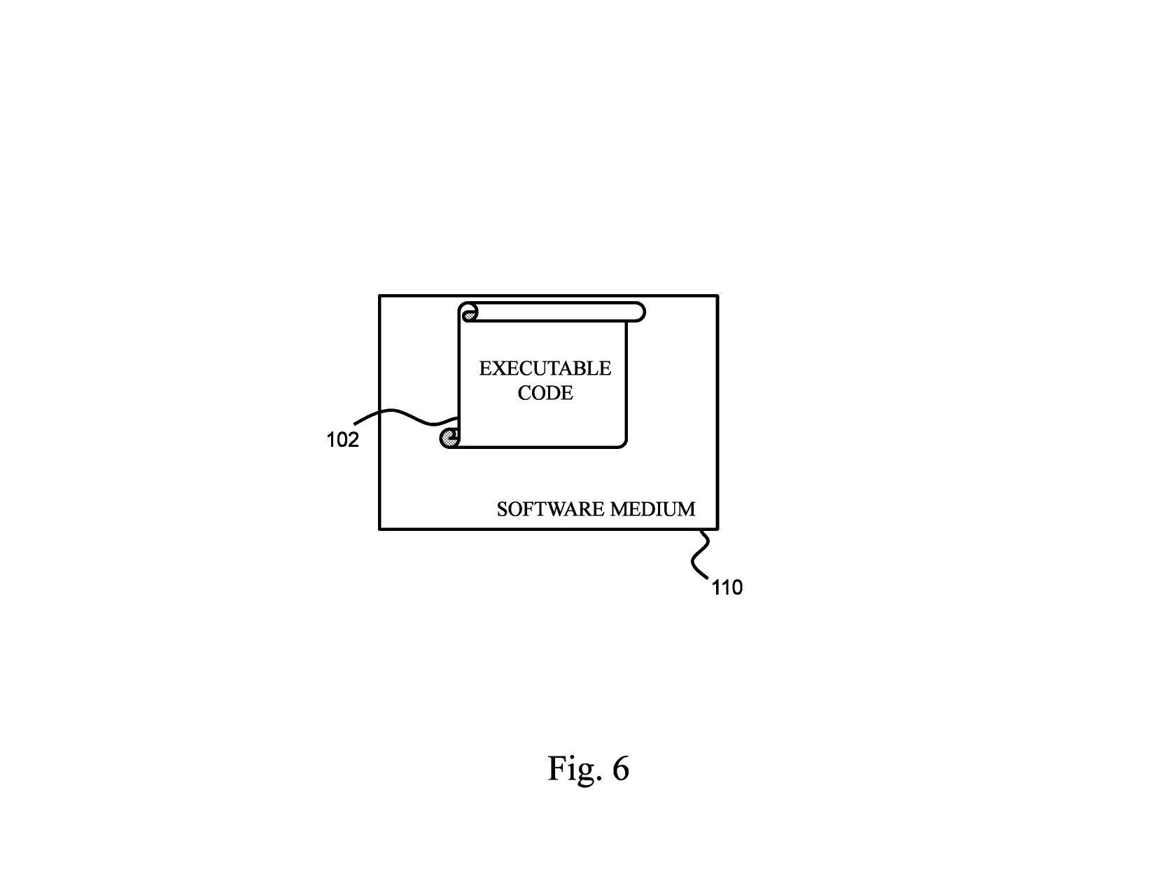

FIG. 6 schematically shows a non-transitory software/computer-readable storage medium 110 according to the disclosure. The storage medium 110 includes executable code 102 configured to, when executed, perform the method according to the disclosure, e.g. as described with respect to either the printer shown in FIG. 1 or the method shown in FIG. 4 and/or according to any of the variants and modifications of the printer and/or of the method described hereinbefore.

The non-transitory computer-readable storage medium 110 may, specifically, be formed as a CD or a CD-ROM, a DVD or a DVD-ROM, a Blu Ray disc or a Blu Ray-ROM disc, a magnetic hard drive, a solid state disk (SSD) hard drive, a USB memory device and so on.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms "comprise", "comprising", "include", "including", "contain", "containing", "have", "having", and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms "a" and "an" used herein are intended to be understood as meaning one or more unless explicitly stated otherwise. Moreover, the terms "first", "second", "third", etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A printing system comprising:
a print engine having printing elements configured to print on print media;
a print controller configured to control the printing on print media by the print engine; and
a cleaning system having at least one cleaning material configured to clean an environment of the printing elements,
wherein the cleaning system includes at least one safety switch to electrically isolate the cleaning system during printing of sheets.

2. The printing system according to claim 1, wherein the cleaning system is positioned at a home position in the printing system besides the printing elements and the cleaning system is moveable underneath the printing elements when cleaning is executed.

3. The printing system according to claim 1, wherein the cleaning system includes a closing element configured to limit access to the cleaning system and surroundings of the cleaning system such that only parts that need to be replaced are accessible, and the at least one safety switch is configured to power off actuators that drive parts in the cleaning system.

4. The printing system according to claim 1, wherein the cleaning system includes at least one mechanical lock configured to lock at least a part of the cleaning system during printing of sheets.

5. The printing system according to claim 4, wherein the mechanical lock is configured to secure a fixed position of the cleaning system such that the unpowered cleaning system is not moved or pushed in the printing system.

6. The printing system according to claim 1, wherein the printing system is an inkjet printing system and the cleaning system includes at least one wipe unit.

7. The printing system according to claim 6, wherein the at least one cleaning material to be replaced is the at least one wipe unit, a tissue ribbon of the at least one wipe unit or other cleaning materials for cleaning printheads.

8. The printing system according to claim 3, wherein the closing element is a hatch or a door.

9. A method for replacing cleaning materials in a cleaning system of a printing system, the printing system including a print engine having printing elements configured to print on print media, a print controller configured to control the printing on print media by the print engine, and the cleaning system having at least one cleaning material configured to clean an environment of the printing elements, the cleaning system includes at least one safety switch to electrically isolate the cleaning system during printing of sheets, the method comprising:
receiving a trigger, by the print controller, that the cleaning material should be replaced;
putting the cleaning system into a physical state to create access with a locked position of the cleaning system;
electrically disconnecting the cleaning system from the print engine by means of the at least one safety switch;
simultaneously printing by the print engine on print media and replacing the cleaning material in the cleaning system; and
upon receipt of a trigger that the cleaning material is replaced,
electrically reconnecting the cleaning system to the print engine by means of the at least one safety switch,
unlocking the cleaning system, and
reactivating the electrical control of the actuators and the cleaning system.

10. The method according to claim 9, wherein the electrically disconnecting the cleaning system from the print engine and electrically reconnecting the cleaning system to the print engine are automatically performed.

11. The method according to claim 9, wherein the electrically disconnecting the cleaning system from the print engine and electrically reconnecting the cleaning system to the print engine are performed by an operator by means of a user interface of the printing system.

12. The method according to claim 9, wherein the receipt of the trigger that the cleaning material is replaced comprises the step of closing a closing element of the printing system, the closing element suitable for closing the cleaning system.

13. A non-transitory computer-readable storage medium storing executable program code configured to, when executed on a printing system including a cleaning system, enable the printing system to perform the steps of the method according to claim 9.
